(19) United States
(12) Patent Application Publication
(10) Pub. No.: US 2024/0370287 A1
(43) Pub. Date: Nov. 7, 2024

(54) OPTIMIZATION OF CLOUD MIGRATION AGAINST CONSTRAINTS

(71) Applicant: INTERNATIONAL BUSINESS MACHINES CORPORATION, Armonk, NY (US)

(72) Inventors: Pranshu Tiwari, Sharon, MA (US); Swarnalata Patel, Morrisville, NC (US); Saurabh Trehan, Gurgaon (IN); Harish Bharti, Pune (IN); Abhaya Kumar Sahoo, Khordha (IN)

(21) Appl. No.: 18/311,951

(22) Filed: May 4, 2023

(51) Int. Cl. G06F 9/455

(52) U.S. Cl. CPC G06F 9/45558; G06F 2009/4557

(57) ABSTRACT

Computer implemented methods, systems, and computer program products include program code executing on a processor(s) that ingests data from one or more computing environments, where the data is related to applications. The processor(s) identifies, based on utilizing topic modeling and latent semantic analysis of the data, homogenous applications among the applications, which include analyzing subdata handled by each application and functionalities of each application; the homogenous applications comprise similarities in the data and in the functionalities. The processor(s) determines overlapping data among the homogenous applications based on the topic modeling, the latent semantic analysis, and term frequency-inverse document frequency of terms in the overlapping data. The processor(s) selects, from the overlapping data, training data. The processor(s) utilizes the training data to calculate weights for disposition metrics and the metrics to predict the resource dispositions for the applications.

### BACKGROUND

The present invention relates generally to the field of distributed computing management and more particularly to optimization of migration decisions in distributed computing environments, including but not limited to cloud computing environments.

Effective management of a technical environment is part of effective management of a business or organization. For example, for a business to run successfully, that business needs to manage its application portfolio effectively, which includes ensuring that applications and the workloads handled by those applications are given maximum business value. As a business (and its needs) grows, the applications that make up its technical infrastructure can grow at an exponential rate and it can become a daunting task for that organization to manage and get value from those applications until all workloads are assessed, rationalized, and optimized.

### SUMMARY

Shortcomings of the prior art are overcome, and additional advantages are provided through the provision of a computer-implemented method for determining resource dispositions for applications in a distributed computing environment. The computer-implemented method can include: ingesting, by one or more processors, data from one or more computing environments, wherein the data is related to the applications; identifying, by the one or more processors, based on utilizing topic modeling and latent semantic analysis of the data, homogenous applications among the applications, wherein the identifying comprises: analyzing, by the one or more processors, data handled by each the application and functionalities of each application, and wherein the homogenous applications comprise similarities in the data and in the functionalities; determining, by the one or more processors, overlapping data among the homogenous applications based on the topic modeling, the latent semantic analysis, and frequency-inverse document frequency of terms in the overlapping data; selecting, by the one or more processors, from the overlapping data of the homogenous applications, training data; utilizing, by the one or more processors, the training data, to calculate weights for disposition metrics; and predicting, by the one or more processors, based on the disposition metrics, the resource dispositions for the applications.

Shortcomings of the prior art are overcome, and additional advantages are provided through the provision of a computer program product for determining resource dispositions for applications in a distributed computing environment. The computer program product comprises a storage medium readable by a one or more processors and storing instructions for execution by the one or more processors for performing a method. The method includes, for instance: ingesting, by the one or more processors, data from one or more computing environments, wherein the data is related to the applications; identifying, by the one or more processors, based on utilizing topic modeling and latent semantic analysis of the data, homogenous applications among the applications, wherein the identifying comprises: analyzing, by the one or more processors, data handled by each the application and functionalities of each application, and wherein the homogenous applications comprise similarities in the data and in the functionalities; determining, by the one or more processors, overlapping data among the homogenous applications based on the topic modeling, the latent semantic analysis, and frequency-inverse document frequency of terms in the overlapping data; selecting, by the one or more processors, from the overlapping data of the homogenous applications, training data; utilizing, by the one or more processors, the training data, to calculate weights for disposition metrics; and predicting, by the one or more processors, based on the disposition metrics, the resource dispositions for the applications.

Shortcomings of the prior art are overcome, and additional advantages are provided through the provision of a system for determining resource dispositions for applications in a distributed computing environment. The system includes: a memory, one or more processors in communication with the memory, and program instructions executable by the one or more processors via the memory to perform a method. The method includes, for instance: ingesting, the by one or more processors, data from one or more computing environments, wherein the data is related to the applications; identifying, by the one or more processors, based on utilizing topic modeling and latent semantic analysis of the data, homogenous applications among the applications, wherein the identifying comprises: analyzing, by the one or more processors, data handled by each the application and functionalities of each application, and wherein the homogenous applications comprise similarities in the data and in the functionalities; determining, by the one or more processors, overlapping data among the homogenous applications based on the topic modeling, the latent semantic analysis, and frequency-inverse document frequency of terms in the overlapping data; selecting, by the one or more processors, from the overlapping data of the homogenous applications, training data; utilizing, by the one or more processors, the training data, to calculate weights for disposition metrics; and predicting, by the one or more processors, based on the disposition metrics, the resource dispositions for the applications.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present invention;

FIG. 2 is a combined workflow and technical architecture illustration that illustrates various components of some embodiments of the present invention;

FIG. 3 is a workflow that provides an overview of various aspects performed by the program code (executing on one or more processors) in some embodiments of the present invention;

FIG. 4 provides a mathematical view of aspects of the workflows described in FIGS. 2-3; and

FIG. 5 is an example of business rules that can be obtained by the program code in the examples herein and utilized to forecast application user growth.

### DETAILED DESCRIPTION

Presently, there is no solution or framework existing that provides a recommendation framework to optimize distributed system (including cloud) migration decisions and alignment against client constraints that leverages various aspects, including but not limited to topic modelling, statistical learning for criterion weightage, and deterministic optimization to select a best application disposition. This approach provides advantages when compared to present tools that generally assess applications based on the CMDB (configuration management database) source or any another manual source that provides application and infrastructure server mapping data. As will be discussed below, these existing tools are ineffective in ever-expanding distributed computing environments (such as cloud computing environments). In contrast to relying exclusively on application and infrastructure server mapping data (as present tools) to manage applications and workloads in a manner that optimizes business utility, methods, computer program products, and computer systems described herein consider historical cloud disposition data to improve recommendation accuracy. Thus, unlike current tools, which rely on data in manually-maintained data sources, in the examples herein, if the data quality is compromised (missing, corrupt, etc.), program code in embodiments of the present invention can generate and utilize a machine learning model to compare similar application profiles and migration patterns by looking into a model dictionary to ensure the model accuracy is high and it meets client constraints as well as (e.g., cloud) service provider migration requirements.

Embodiments of the present invention also include a framework that considers NFRs (Non-functional Requirements) when providing distributed system (e.g., cloud) dispositions. As such, the program code analyzes data from logs utilizing observability and based on the analysis, the program code provides recommendations. By utilizing the logs, the program code can identify how many times given transactions occur, peak load of the transactions per second, average response time, and/or success/failure rate. The recommendations provided by the program code take into account this granularity. For example, if a given microservice is utilized frequently, the program code can recommend that this microservice be rationalized on priority when compared to other microservices. The program code can leverage a hybrid multi cloud to address these NFRs.

Embodiments of the present invention include computer-implemented methods, computer program products, and computer systems where program code executing on one or more processors recommends a framework to optimize distributed computing (e.g., cloud) migration decisions and align against client constraints. In recommending the framework, the program code leverages topic modelling, statistical learning for criterion weightage, and deterministic optimization to select a best application disposition. To provide this framework, in some examples herein, the program code provides a nodal ingestion and homogeneous target application selector engine to select applications in a technical environment that are similar to target applications, based on functionality, data based on topic modeling, semantic analysis, and key word matching. The program code in some examples determines functionality and data overlap among homogeneous target applications through topic modelling, latent semantic analysis (e.g., in which the program code analyzes functionality similarities) and term frequency-inverse document frequency or TF-IDF (i.e., term frequency-inverse document frequency, in which the program code analyzes data similarities). TF-IDF is a measure, used in the fields of information retrieval (IR) and machine learning, that can quantify the importance or relevance of string representations (words, phrases, etc.) in a document amongst a collection of documents. In some examples herein, the program code selects training data in a data generator. The program code can calculate weights for cloud disposition metrics leveraging statistical learning and predicting cloud high level target disposition such as retire, retain, re-engineer. The program code can also determine which applications should be placed in a target cloud disposition re-engineer category by leveraging deterministic integer programming. In some embodiments of the present invention, the program code can automatically implement the recommendations.

Retiring, in cloud (or resource) disposition, includes identifying assets and services that can be turned off so the business can focus on services that are widely used and of immediate value. Retaining, in cloud (or resource) disposition, includes retaining portions of an information technology (IT) portfolio, for example, because there are some applications that it is not advantageous to migrate immediately. Re-engineering can include re-hosting (e.g., lifting-and-shifting) applications, re-platforming, which involves making changes to an application before shifting it to a new resource (e.g., cloud), re-purchasing (e.g., moving to a different product), and/or refactoring or re-architecting, which can include re-developing an application (possibly re-imagining it) utilizing features native to a new environment. In some embodiments herein, the re-engineer category includes refactoring, re-migrating and re-architecting categories.

When compared to existing tools that provide recommendations for migration, aspects of embodiments of the present invention provide significant advantages. First, as noted earlier, no current tool or method can provide a recommendation framework to optimize distributed system (including cloud) migration decisions and alignment against client constraints based on topic modelling, statistical learning for criterion weightage, and deterministic optimization. For example, although some current approaches can discover a latent computing property preference of an entity operating in a first computing environment and recommend a computing environment migration plan to a second computing environment based on the latent computing property preference of the entity, this approach, unlike the embodiments described herein, does not factor client intent, business objective, and pain points, into its optimization recommendations. Unlike existing approaches, in embodiments of the present invention, the program code analyzes each homogenous application in a technical environment for its functionality, scalability, and nonfunctional requirements because the program code dynamically analyzes the logs of these applications. In embodiments of the present invention, the program code analyzes the data from logs utilizing observability and based on this analysis, the program code can provide recommendations (which can be implemented automatically by the program code in some embodiments of the present invention). Although some existing approaches can recommend target cloud dispositions and cloud providers, these approaches do not, like the program code in embodiments in the present invention, consider engineering components that select the application which are similar to target application in terms of functionality, data based on topic modeling, semantic analysis, and/or key words matching. As will be discussed herein, this targeting provides an advantage over the existing approaches.

In the systems, methods, and computer program products described herein, the program code can provide recommendations for (and optionally implement) cloud migration decisions throughout a lifecycle of an enterprise. Various existing approaches are limited to providing recommendations at the beginning of the rationalization process, which is less effective as computing environments are constantly in flux and thus, the flexibility of the timing in embodiments of the present invention enables the present invention to provide a significant advantage over existing approaches. Additionally, in embodiments of the present invention, the program code can store data as a cohort; each cohort has unique client name and application name. Thus, the program code in embodiments of the present invention can obtain data from multiple service providers, including multiple cloud vendors, at the same time or within a similar timeframe.

In embodiments of the present invention, program code analyzes each homogenous application via study and analysis of terms of functionality, scalability, and non-functional requirements, by dynamically analyzing the application logs. The program code analyzes the data from the log utilizing observability and based on the analysis, provides recommendations. In embodiments of the present invention, the program code generates a recommendation framework that can consider inputs (from its application scanner tool) that will: a) access the application code, configuration, and deployment strategy; b) identify the architecture model of the application monolithic or microservice based resources (e.g., based on WAR/JAR file or other indicators); c) analyze data sources accessed (including the type kind of access, e.g., read and/or write/update; d) analyze high level business functions performed; e) analyze deployment strategy (including but not limited to whether it is manual and/or automatic, including via a DevOps tool chain and/or Agile); f) determine a list of communication protocol being used (REST (representational state transfer), SOAP (simple object access protocol), etc.); g) determine a list of the interfaces; h) determine a list of interface calls being made; and/or i) a number of transactions performed in the application. Thus, the program code scans and ingests various aspects of the application to generate (and optionally automatically implement) recommendations.

Not only do various aspects of the examples herein provide significantly more than existing approaches to optimization of migration decisions in distributed computing environments, embodiments of the present invention are also inextricably tied to computing and are directed to a practical application. The examples described herein are inextricably linked to computing as the examples herein provide systems, methods, and computer program products that optimize and can potentially implement migration decisions in distributed computing environments, including, but not limited to, cloud computing environments. Practical applications include the program code generating and implementing optimization recommendations in computing environments (based on aspects that are particular to these environments, such as components of the applications executed by the processors in the environment) and providing and implementing these migration recommendations throughout a lifecycle of an enterprise. Thus, the program code in embodiments of the present invention can improve the functionality and efficacy of distributed computing environments, including cloud computing environments.

One or more aspects of the present invention are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing a process (or multiple processes) that, e.g., facilitates granular real-time data attainment and delivery including as relevant to soliciting, generating, and timely transmitting, granular product review to consumers. Aspects of the present invention are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

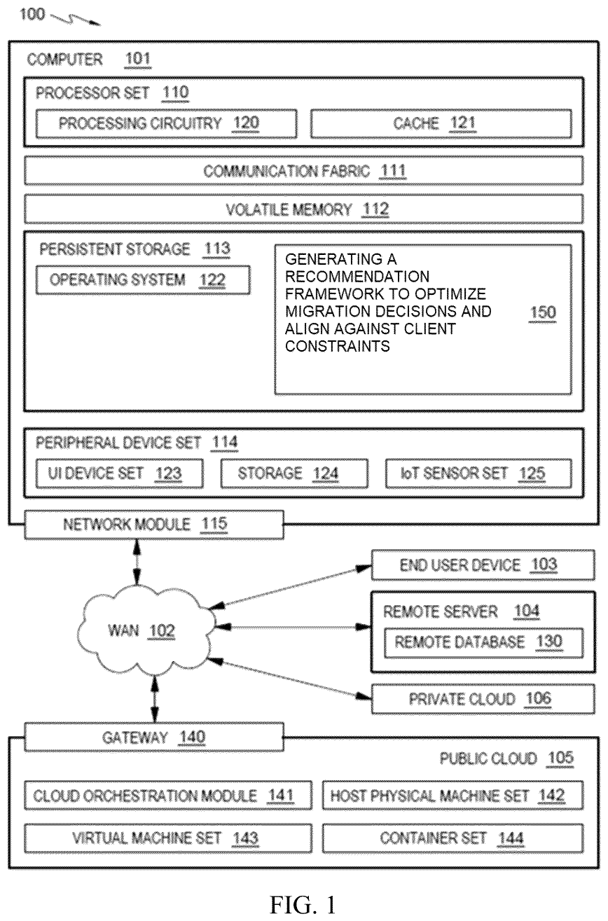

One example of a computing environment to perform, incorporate and/or use one or more aspects of the present invention is described with reference to FIG. 1. In one example, a computing environment 100 contains an example of an environment for the execution of at least some of the computer code involved in performing the inventive methods, such as a code block for generating a recommendation framework to optimize distributed computing (e.g., cloud) migration decisions and align against client constraints 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

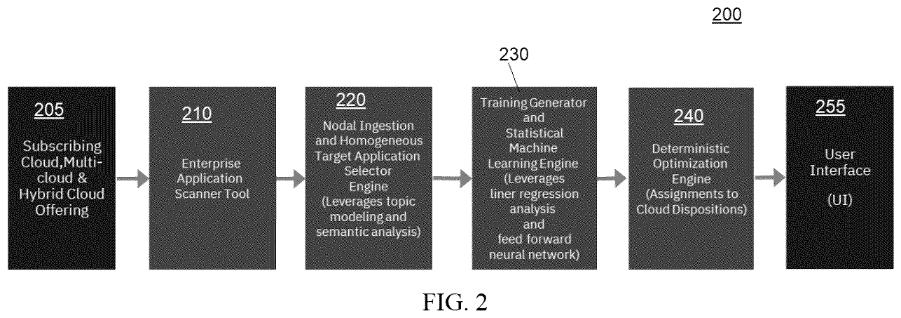

FIG. 2 is a combined workflow and technical architecture illustration 200 that illustrates various components of some embodiments of the present invention. Although various aspects are illustrated as separate components, this configuration was selected for ease of understanding and not to suggest any limitations. The technical architecture can combine various components or further divide these individual components, which can comprise one or more modules of program code. The separation of these aspects is for illustrative purposes only. Referring to FIG. 2, the components (which can comprise software and/or hardware) of the relationship diagram include program code (which can be executed by one or more processors) comprising an application scanner 210, program code comprising a nodal ingestion and homogeneous target application selector engine 220 (which identifies functional and/or data overlap between applications in a distributes computing environment), program code comprising a training generator and statistical machine learning engine 230, and program code comprising a deterministic optimization engine 240 (which makes and in some examples, automatically implements, recommendations). Enterprise applications 205 (including but not limited to subscribing cloud, multi-cloud, and hybrid cloud offerings) provide input to the application scanner 210, and after moving through the various components, the deterministic optimization engine 240 outputs recommendations to a user interface 255. As aforementioned, in some embodiments of the present invention, the program code automatically implements the recommendations.

In some embodiments of the present invention, program code comprising an application scanner 210 obtains input (data) from the enterprise applications 205 in one or more distributed computing environments (e.g., cloud computing environments) by accessing the application code, configuration, and/or deployment strategy of each application (e.g., application data). Based on the data ingested, the program code can identify application aspects including, but not limited to, the application model architecture (e.g., as monolithic or microservice-based), data sources accessed by the application, high level business functions performed by the application, the deployment strategy of the application, communication protocol(s) utilized by the application, interface applications to the application, and/or transactions performed by the application. The program code of the application scanner 210 can obtain the information based on subscribing to offerings (e.g., cloud offerings) via an application programming interface (API). Enterprise applications can include any applications and for this reason, both the terms enterprise application and application are used herein.

The program code of the application scanner 210 can provide the application aspects of the enterprise applications 205 to the nodal ingestion and homogeneous target application selector engine 220. The program code of the nodal ingestion component 220 selects applications which are similar to target applications based on performing topic modelling and semantic analysis. (The aspects that enable the program code to determine that applications are similar or homogenous are discussed herein.) The program code of the nodal ingestion and homogeneous target application selector engine 220 selects the applications which are similar to target application based on aspects including but not limited to functionality, data based on topic modeling, semantic analysis, and/or key words matching. The program code can select functional and depth coverage among homogeneous applications in terms of functionality and/or scalability utilizing semantic and topic modeling. Semantic modeling includes the program code generating a semantic data model. In generating this model, the program code structures data (in this example, the application data) to represent it in a specific logical way. Semantic information adds a basic meaning to the data and the relationships that lie between them. Meanwhile, topic modeling is a machine learning technique that automatically analyzes text data to determine cluster words for a set of documents. Topic modeling comprises unsupervised machine learning because it doesn't require a predefined list of tags or training data that has been previously classified by humans. Thus, the program code can recognize similarities between different enterprise programs based on various data associated with these programs.

The program code of the homogeneous target application selector engine 220 provides the similarities of the enterprise applications 205 to target applications to the program code of the training generator and statistical machine learning engine 230. The program code of the training generator and statistical machine learning engine 230 can be understood as an engineering component that selects cohorts. The program code of the homogeneous target application selector engine 230 selects relevant cohorts on the basis of factors, including but not limited to domain, applications, and/or workload. The program code utilizes a linear regression analysis and a (e.g., feed forward) neural network (NN) to select weights for adaptability score and scalability score. The program code utilizes machine learning to predict retire, retain and/or re-engineer probabilities for the enterprise applications 205. The program code can further identify the re-engineer probabilities as refactor, remigrate, and re-architect probabilities. In a feed forward NN, the nodes do not form loop, but, instead, in this multi-layer neural network, information is passed forward. During data flow, input nodes receive data, which travel through hidden layers, and exit output nodes.

In some embodiments of the present invention, the program code comprising the training generator and statistical machine learning engine 230 performs a (linear) regression to generate weights for the adaptability score and scalability score of each enterprise application 205 by utilizing a machine learning system that includes a NN. In certain embodiments of the present invention, the program code utilizes supervised, semi-supervised, or unsupervised deep learning through a single- or multi-layer NN to correlate various attributes from the enterprise application data. The program code utilizes resources of the NN to identify and weight connections based on, domain, applications, and/or workload (and/or other attribute sets gathered). For example, the NN can identify certain data that are indicative of metrics related to scalability and adaptability (e.g., based on pre-defined ranges). In this way, the program code can classify enterprise applications 205 and based on the classifications, select weights for adaptability score and scalability score. The program code utilizes machine learning to predict retire, retain and/or re-engineer probabilities for the enterprise applications 205. The program code can additionally identify any re-engineer probabilities as refactor, remigrate, and/or re-architect probabilities.

As understood by one of skill in the art, neural networks are a biologically inspired programming paradigm that enable a computer to learn from diverse data sets, including the data from the enterprise applications 205. This learning is referred to as deep learning, which is a set of techniques for learning in neural networks. Neural networks, including modular neural networks, are capable of pattern recognition with speed, accuracy, and efficiency, in a situation where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning both provide assistance in parsing both structures and unstructured data across multiple resources in a technical environment. Thus, by utilizing an NN, the program code can identify attributes and classify these attributes as indicative of the scalability and adaptability of the enterprise applications 205. The machine learning (assisted by the NN) enables the program code to predict retire, retain and/or re-engineer probabilities for the enterprise applications 205.

Program code comprising a deterministic optimization engine 240 obtains the enterprise application data and the results of the determinations of the earlier components, including the retire, retain and/or re-engineer probabilities of the enterprise applications 205. The program code takes as additional inputs client-drive constraints, including, but not limited to, budgets and/or project costs. The program code utilizes integer programming to select enterprise applications 205 bucketed by the program code as re-engineer (e.g., refactor/rearchitect, re-platform, rehost, repurchase). Integer programming is a class of problems that can be expressed as the optimization of a linear function subject to a set of linear constraints over integer variables. The input constraints are the constraints utilized by the program code in making this determination. In some examples, the program code comprising the deterministic optimization engine 240 takes input constraints from client budgets and/or project costs and utilizes integer programming to select a distributed system plan (e.g., cloud disposition) among the re-engineer high level disposition (e.g., refactor/rearchitect, re-platform, rehost, and/or repurchase) based on constraints. In some examples, a disposition plan related to migration across distributed systems and architectures, including cloud computing environments, includes activities and requirements, references cohorts and waves with assignments to cohorts being validated through the process.

The program code of the deterministic optimization engine 240, which generates assignments to (cloud) dispositions, provides recommendations that can be viewed via the user interface 255. The program code can provide recommendations throughout the lifecycle of the enterprise 205 for optimization. As aforementioned, while existing tools provide recommendations only at the beginning of the rationalization process, in the examples herein, the program code (e.g., recommendation framework) provides recommendation for-pre, during, post of application rationalization. These recommendations can be utilized (or implemented automatically) to modernize the distributed computing system or system utilized by the enterprise application(s) 205 but can also modernize the distributed computing system (e.g., the cloud) on an ongoing basis. For example, the program code can generate a disposition to rehost enterprise applications 205 to a different system (e.g., cloud). As illustrated in FIG. 2, the program code can subscribe (ingest data) from different offerings (including different cloud offerings). Thus, the program code (utilizing the framework it generates) can provide recommendation for hybrid multi-cloud environments.

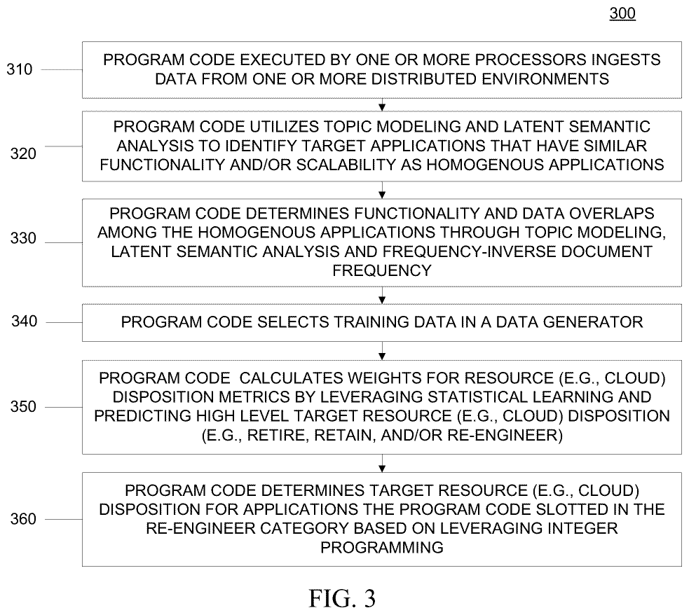

FIG. 3 is a workflow 300 that provides an overview of various aspects performed by the program code (executing on one or more processors) in some embodiments of the present invention. Certain of these aspects were also illustrated in FIG. 2. As illustrated in FIG. 3, in some embodiments of the present invention, program code executed by one or more processors ingests data from one or more distributed environments (310). For example, the program code (referred to as a nodal ingestion engine) can take data from cloud (or other distributed environment) offerings from multiple vendors, multiple sources, and enterprise application scanners to store different document attributes as cohorts. Each cohort is unique and has an associated FRD (functional requirements document) and NFR (non-functional requirements). The program code ingesting the data can generate a table or other data record. Each record identifies, for each application, the client, domain, application, functional document name, non-functional requirement document name, and data attributes.

The program code utilizes topic modeling and latent semantic analysis (analysis of functionality) to identify target applications (among the applications in the distributed environments) that have similar functionality and/or scalability to identify homogenous applications (320). Topic modeling includes the program code applying an unsupervised machine learning algorithm to convert unstructured content into structured formats by detecting word and phrase patterns within the content, and clustering word groups and similar expressions that best characterize a set of similar documents. Various existing algorithms can be utilized by the program code to detect these content similarities. Thus, to determine whether applications are homogeneous, the program code looks both at the data handled by the applications as well as the functionality of the applications.

The program code determines functionality and data overlaps among the homogenous applications utilizes topic modeling, latent semantic analysis and TF-IDF (data) (term frequency-inverse document frequency-based on relevance feedback, can include a word weighting method, document length normalization, and a similarity measure) (330). As noted, TF-IDF stands for term frequency-inverse document frequency and it is a measure, used in the fields of information retrieval (IR) and machine learning, that can quantify the importance or relevance of string representations (words, phrases, etc.) in a document amongst a collection of documents (also known as a corpus). Term frequency looks at a frequency of a particular term relative to a document or corpus of documents, which can include the raw count (number of times it appears), term frequency adjusted for the length of the document, logarithmically scaled frequency, and/or Boolean frequency (e.g., 1 if the term occurs, or 0 if the term does not occur, in the document). Inverse document frequency determines whether a word is common (or uncommon) in a corpus.

As stated above, the program code construes that applications are similar (e.g., homogenous) based on: 1) functionality; and 2) scalability and volumetrics/NFRs. In some examples, the program code utilizes natural language processing (NLP) to determine functionality of overlaps and latent semantic analysis to determine different topics to determine the extent of overlap between functionalities. The program code can then calculate the most similar documents based on topics. Once the program code identifies a similar application, the program code executes the same latent semantic analysis with each requirement as each document to identify the overlap of functionality between the documents (e.g., the data ingested is structed into documents). The latent semantic analysis can be understood as a first cut to locate homogeneity in applications. In some of these examples, the NLP analysis utilizes a bag-of-words model, which is a simplified representation used in NLP and information retrieval (IR).

In this model, a text (such as a sentence or a document) is represented as the bag (multiset) of its words, disregarding grammar and even word order but keeping multiplicity. As discussed herein, the program code establishes that certain applications are similar based on semantic analysis and thus, the bag-of-words model enables the program code to determine overlaps between applications.

In some examples, the program code utilizes equation series below (e.g., construct) to convert each functional document to a TF-IDF vector document where:
D=total documents
tᵢ=term or word
tf(t,r)=Σᵢ₌₀^{V}f(x, d)
x is index
d is the FRD
t is the word

$$t f ( t , r ) = 1 if x = t else 0$$

$${TF}_{I} DF = tf ( t , r ) * idf ( t ) ,$$

where idf(t) is as defined below

These values are combined in Equation 1 below.

$$idf ( {t}_{i} \vert D ) = log \frac{( D )}{( tf ( {t}_{i} , \vert D ) + 1 )} \qquad ( Equation 1 )$$

The program code uses single vector decomposition to extract features that simulate topics of documents. Since TF-IDF architecture had a feature vector size of F, in some examples, the program code can reduce the features such that the program code can capture ˜80% of variance. The technique illustrated utilizes principal component analysis (PCA), which is a technique for reducing the dimensionality of such datasets, increasing interpretability but at the same time minimizing information loss. One manner at which to arrive at PCA is by utilizing singular value decomposition (SVD) if the initial matrix is normalized. If a document's vector is a normalized vector, the program code can utilize the SVD equation, labeled Equation 2, below.

$$X = U * \sum * {V}^{T} \qquad ( Equation 2 )$$

In this example, Cov=X^{T}X. X is a normalized TF-IDF Matrix. U and V are left and right singular vectors of X. The program code can tune the number of principal components to preserve the information as per Equation 3 below.

$${λ}_{i} = {\sum }_{ii}^{2} \qquad ( Equation 3 )$$

The program code can compute the reconstructed matrix, which can be computed by x*V. The program code can also utilize a method that models topics. In this example, an enterprise has “n” distinct applications. The program code generates a corpus of documents that it stores in a nodal document agent. This nodal document agent will contain all the corpus documents. Each application can have: a functional document, a non-functional document, and a data dictionary (obtained by the program code from the data object of the applications).

In this example, \vec{X} is a vector of documents in R^{N} where N represents a number of functional documents or NFRs in an enterprise. Each documents corpus has “V” words in vocabulary. The total topics covered by each functional document is “K”.

In this example:
Word in vocabulary in Document xᵢϵ1,2 . . . . V
Topic Assignment zᵢϵ1, . . . K
\vec{θ}=[θ₁, θ₂, θ₃ . . . θₖ] is a vector of probabilities that can be assigned to each topic which is covered in functional document. These values are all included in the Equation 4 below.

$$\sum {θ}_{k} = 1 \qquad ( Equation 4 )$$

Hence, the program code can infer that probability of topic zᵢ for a given functional document, as illustrated in Equation 5 below.

$$p ( {z}_{i} = k \vert \vec{θ} ) = {θ}_{k} \qquad ( Equation 5 )$$

βₖ is a topic's word probabilities over the vocabulary.
βk=[β_{k,1}, β_{k,2} . . . ] represent k topics word probabilities over vocabulary.
zᵢ˜Discrete(\vec{θ}) is a number of picks for a topic for a given FRD.
xᵢ|zᵢ=k˜Discrete(βₖ) is a number picking a word for given topic of FRD or NFR document.

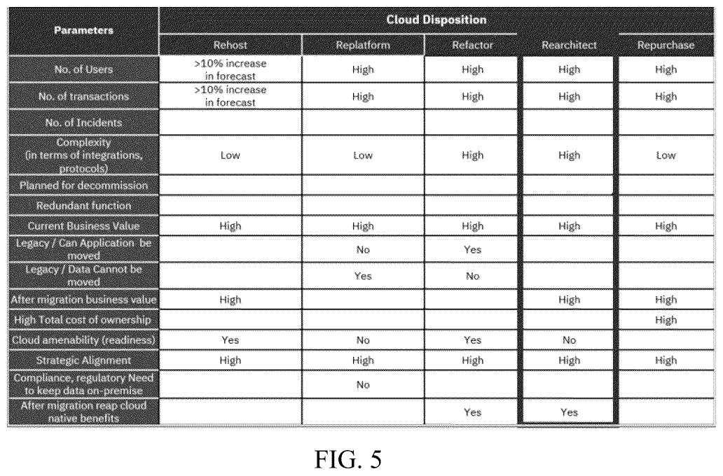

The program code models topics from a different application/FRD to create topics, documents from a nodal agent (zₖ) and assignment (θₖ). Each document is linked to topics by the program code. The linkages created by the program code are illustrated in FIG. 5. As illustrated in FIG. 5, each document below dₖ is linked to topics \vec{θ}, \vec{β}; \vec{θ}ϵR^{K}, \vec{β}ϵR^{V}. The linkage of a document x represents positions in the document while X represents a word vector. In FIG. 5, each functional document of an application is represented as a bag of words vector (as noted above, the program code can utilize NLP and a bag-of-words model). Each functional document of the application in the example is provided by a bag of words vector that can be denoted as follows.

$${X}_{d} = [ {X}_{11 ,} {X}_{12} , {X}_{13} ... {X}_{1 , Nd} ]$$

$${X}_{11 ,} = {\sum }_{1}^{{N}_{d}} I ( {x}_{d , v} = 1 ) {N}_{d} - size of d$$

K represents the number of topics, as illustrated in both Equations 6 and 7 below.

$$E ( {X}_{dv} ) = {N}_{d} * p ( {x}_{d , n} = v \vert \vec{θ} , \vec{β} ) = {N}_{d} {\sum }_{k = 1}^{K} {θ}_{d , k} {β}_{\{ k , v )} \qquad ( Equation 6 )$$

$$E ( {X}_{d} ) = N * \vec{{θ}_{d}} * \vec{{β}_{k}} \qquad ( Equation 7 )$$

The program code determined (in this example) that there are many FRDs and NFRs for an enterprise, which is denoted as follows:

$$E ( X ) = N * θ * β$$

θ is d*k matrix while β is k*v matrix.

In this example, d is the documents in the nodal documents engine and k is the number of topics, while v represents the vocabulary.

The program code can utilize single vector decomposition of above matrix to project the above matrix in lower dimensional space (e.g., when projecting a d*V matrix to a new projection space).

$$X ∼ U * \sum * {V}^{T}$$

$$Z = \sum * {V}^{T}$$

In some examples, the program code utilizes principal component analysis (PCA) to minimize any reconstruction error. As such, the program code equates topic models by SVD through the statements below.

$$X = N * θ * β$$

$${N}^{( - 1 )} * X = θ ( d * k ) * β ( k * v )$$

θ, β are constrained probability Vectors.

In some examples, the program code can utilize a Bayes theorem of P(A|B)=P(A|B,C)*P(C). This example is expanded upon below in Equations 8 and 9.

$$p ( {x}_{d , n} = v \vert β , {θ}_{d} ) = {\sum }_{1}^{k = K} p ( {x}_{d , n} = v \vert β , {z}_{d , n} = k ) \cdot p ( {z}_{d , n} = k \vert {θ}_{k} ) \qquad ( Equation 8 )$$

$$p ( {x}_{d , n} = v \vert β , {θ}_{d} ) = {\sum }_{1}^{K} β * {θ}_{k} \qquad ( Equation 9 )$$

Leveraging the two equations about, the program code can procced with an E-M algorithm to max Log p(x_{d,n}=v|β, θ_{b}).

Thus, the program code can utilize both topic modelling and latent semantic analysis to identify closest applications based on both a functional and non-functional document (FRDs and NFRs) The output of the program code identifies homogenous applications.

The table below demonstrates target output for a functional analysis based on topic modelling and a latent semantic analysis.

| Target Application | Homogeneous Application | Functional |
|---|---|---|
| Application 1 | Application 5 | 0.8 |
| Application 1 | Application 6 | 0.9 |

The table below demonstrates target output for a non-functional analysis based on topic modelling and a latent semantic analysis.

| Target Application | Homogeneous Application | Functional |
|---|---|---|
| Application 1 | Application 10 | 0.8 |
| Application 1 | Application 10 | 0.85 |

Thus, the program code determines functionality and data overlap among homogeneous applications through topic modeling, latent semantic analysis (functionality), and TFID (data) (330).

Returning to FIG. 3, the program code selects training data in a data generator (340). In some examples, the program code selects historical projects with similarities, including, but not limited to, similar strategic intent, domain constraints, and cost constraints. In some examples, the program code selects observation vectors from historical data based on factors, including but not limited to: domain business, strategic imperative, migration cost range (e.g., low/medium/high based on pre-defined thresholds), integration cost range (e.g., low/medium/high based on pre-defined thresholds), client budget range (e.g., low/medium/high based on pre-defined thresholds), and/or workload pattern similarity (index).

The program code then calculates weights for resource (e.g., cloud) disposition metrics by leveraging statistical learning and predicting high level target resource (e.g., cloud) disposition (e.g., retire, retain, and/or re-engineer) (350). In some examples, this aspect includes two parts: 1) the program code calculates an intermediate function to determine target variable (e.g., code scalability, change adaptability, testable adaptability, deployment adaptability, general architecture scalability, etc.) and 2) the program code determines high level cloud dispositions. Regarding the latter, in some examples, the dispositions are limited to three high level dispositions: retire, retain, and re-engineer.

Below is a more detailed example of the program code that calculates an intermediate function to determine target variable. In calculating the intermediate function, the program code can assign a target variable for each function fas yᵢ. In y_{id}=f(\vec{x}), i is the index number for which the program code generates a score. y_{1d} represents a code adaptability score for d, a given application. Meanwhile, y_{2d} is the test adaptability score e for the d application. y_{3d} is the deployment adaptability score for the d application. y_{4d} is the scalability code for the d application, and y_{5d} is the strategic alignment score for the d application.

Coding Change Adaptability can be represented by y₁. Since key words are known, based on the earlier NPL analysis and other parts of the workflow 300, the program code creates a pattern of words and will see if the pattern of words reoccurs in a document. Based on a term frequency document, the program code can create key word search. An examples of a keyword search for Microservice Architecture could include, for example, API (application programming interface), service, circuit breaker, service, registry, template, access token, event sourcing, saga, observability, and/or agile. Examples of keywords for a monolithic architecture, in contrast, could include waterfall, vendor lock-in, one code base for all functionalities, manual checking of logs, and/or non-agile.

Testable adaptability can be represented by y₂. This is a test-driven architecture, including an automated health check in which the program code tests application health at intervals (e.g., fifteen minutes) every 15 mins. In a non-test-driven architecture, the program code can test this aspect once, after a build is complete.

Deployment adaptability (y₃) utilizes microservice architecture key words, which can include but are not limited to, DecSecOps, CI/CD Pipeline, containerized, frequent deployment cycle, and/or minimal downtime. Monolithic architecture key words can include manual deployment, significant downtime.

For scalability score (y₄) the program code can utilize microservice architecture key words, including, but not limited to, containerized, deployment, horizontal autoscaler, autoscale, webhook, multiple containers, pod, and resource. The program code can utilize monolithic architecture key words for this aspect, including but not limited to, WAR, JAR, and one executable.

X_{d} can be a vector of documents that represents term-frequency documents of presence of words in the document. The program code can create a function such that f_{id}: Rⁿ→R to create an adaptability score, a scalability score, and a business objective score.

$$\vec{{y}_{d}} is vector = [ \begin{matrix}{y}_{1 d} \\ {y}_{2 d} \\ {y}_{5 d}\end{matrix} ]$$

$$\vec{{x}_{1}} = [ {tf}_{11} , {tf}_{21} , {tf}_{31} ... ... ]$$

In this example, X is a set of all observations and/or measurements of TF-IDF vectors of different application documents where s={(\vec{x₁}, \vec{x₂} . . . \vec{xₙ})}.

XϵR^{n*m} is a matrix where n is the number of application documents and m feature vector of TF-IDF.

The program code can utilize an NN and/or an analytical solution to determine weights. For example, the program can determine the weights using Equation 10 below.

$$Weights = \vec{β} = {( λ I + {X}^{T} X )}^{- 1} {X}^{T} Y \qquad ( Equation 10 )$$

Equation 11 is the predicted score for the ith dimension of y for the dth application.

$${y}_{i , d} = \vec{β} \cdot X \qquad ( Equation 11 )$$

When utilizing an NN (e.g., in a big data situation), the following calculations can be utilized.

$$p ( {y}_{i} \vert \vec{{x}_{ι}} , θ ) = N ( y \vert f ( \vec{{x}_{ι}} ) , {σ}^{2} ) … = > \vec{x} ∈ {R}^{d} ,$$

$$y ∈ Randy = f ( x ) + ε where ε = N ( 0 , {σ}^{2} )$$

p(y|X,θ)=N(y|X,θ,σ²) where X is vector of Random Variables

p(yₙ|\vec{xₙ}), is the likelihood of probability density function of y at x^{T} and hence y=xₙ^{T} θ+ε. If Y={y₁, y₂, y₃ . . . y_{N}} & X=\vec{x₁}, \vec{x₂}, \vec{xₙ}, then:

$$p ( Y \vert X , θ ) = p ( {y}_{1} \vert \vec{x} ) * p ( {y}_{2} \vert \vec{{x}_{2}} ) * p ( {y}_{n} \vert \vec{{x}_{n}} ) = {\prod }_{i = 1}^{n} p ( {y}_{i} \vert \vec{p ( {x}_{ι} )} )$$

The program code can take the logs of both sides as exemplified below, leading to Equation 12.

$$- log P ( y {\vert}_{1} X , θ ) … = - log {\prod }_{n = 1}^{N} P ( {y}_{n} \vert {x}_{n} θ ) … taking log both sides \qquad ( Equation 12 )$$

$$⇒ - log P ( y \vert X , θ ) = - {\sum }_{n}^{N} log P ( {y}_{n} \vert {x}_{n} , θ )$$

$$⇒ L ( θ ) = - log P ( y \vert X , θ ) = - log ( \frac{1}{\sqrt{2 π {σ}^{2}}} * {e}^{( \frac{{( y - {x}^{T} θ )}^{2}}{2 * {σ}^{2}}} )$$

$$⇒ L ( θ ) = - \frac{1}{2 {σ}^{2}} {( {y}_{n} - {x}_{n}^{T} θ )}^{2} + {\sum }_{n = 1}^{N} log ( 1 / ( \sqrt{2 * π {σ}^{2} )}$$

The program code can minimize using a gradient descent algorithm. For example, a vector,

$$\vec{θ} = [ \begin{matrix}{θ}_{1} \\ {θ}_{k}\end{matrix} ]$$

can represent parametric vector. The program code can set an iteration to 0 and put initial parameters for a leaning rate of (η) and Epsilon. The program code calculates the gradient vector ∇L(\vec{θ}). The following values are included in this non-limiting example.

$$∇ L ( \vec{θ} ) > Epsilon :$$

$$\vec{{θ}_{N + 1}} = {\vec{θ}}_{N} - η {\sum }_{i - 1}^{N} \{ ∇ {L ( \vec{θ} )}^{T} )$$

N refers to training measurements over X. Y in the example above. N=N+1 while Return \vec{θ} {Optimized value with k components}.

The program code utilizes the target variable y (e.g., scalability, adaptability) as input to predict high level disposition. The program code them determined the high level disposition of the applications. The program code predicts the disposition score using Equation 13 below.

$${r}_{d} = g ( {\vec{y}}_{d} ) \qquad ( Equation 13 )$$

The loss function for high level disposition are as below as Equation 14.

$$L ( θ ) = - \frac{1}{2 {σ}^{2}} {( {r}_{n} - {y}_{n}^{T} θ )}^{2} + {\sum }_{n = 1}^{N} log ( 1 / ( \sqrt{2 * π {σ}^{2} )} \qquad ( Equation 14 )$$

The program code derives the unction g using the following values.
r_{1d}-Retire for application d
r_{2d}-Retain for application d
r_{3d}-Re-engineer for application d

Each disposition value r_{d} is vector value for each disposition decision, the values of y id as g_{d}: R⁴→R will create a disposition vector value for each vector. The program code can utilize the loss function for high level disposition equation above to adjust the weightage.

Returning to FIG. 3, the program code determines target resource (e.g., cloud) disposition for applications the program code slotted in the re-engineer category based on leveraging integer programming (360). The program code (using machine learning) generated target dispositions based on technical history. These dispositions, in some examples, include, retire, retain, and re-engineer. For the applications in the latter category, the program code generates further dispositions for re-engineering the applications while crediting factors including, but not limited to, strategic vision, current operating model, and/or operating characteristics of clients' environments. The program code can use deterministic optimization by leveraging principles of assignment programming in making these dispositions. Various factors that can affect infrastructure decisions and (cloud) application rationalization, including, but not limited to, client objectives, funding availability, and/or resource availability. In these examples, the program code can utilize constraints-based integer programming to determine which category to follow, based on data related to the amount of integration needed to re-engineer each application bucketed as “re-engineer.” In a given (non-limiting) example, provided only to illustrate various aspects of some examples herein, the program code determines that of ten applications, one should return Application 9, retain Application 10, and re-engineer the remainder, Application 1-Application 8. These results are the high level cloud disposition of these ten applications. The program code then can further delve into this category and the applications bucketed, taking into consideration factors including, but not limited to, integration cost and migration cost as related to any resources utilized in a migration. The decision variable can be defined as follows.

| | |
|---|---|
| Refactor, Rearchitecture | R_{1d}; ∈ [0, 1] |
| Re-platform | R_{2d}; ∈ [0, 1] |
| Rehost | R_{3d}; ∈ [0, 1] |
| Re-purchase | R_{4d}; ∈ [0, 1] |

The program code can derive a minimum objective function, noted below as Equation 15.

$$\vec{Z} = {\vec{Z}}_{1} + {\vec{Z}}_{2} + {\vec{Z}}_{3} \qquad ( Equation 15 )$$

The values referenced are as follow:
d=Number of Applications
\vec{Z}₁=Total Migration Cost=\vec{C₁}·(\vec{N}); \vec{c₁} is Migration Cost Vector R^{M}
\vec{Z}₂=Total Integration Cost=\vec{V}·\vec{C}₂; \vec{c₂} is Integration Cost Vector R^{M}
\vec{Z}₃=Total Modernization cost
\vec{O}·\vec{C}₃; \vec{C₃} is Modernization Cost Vector in R^{M}
M=Number of Applications recommended for re-engineering

The program code observes various constraints. M is the number of applications for modernization. Below is a listing of various constraints, which are provided, in this example, as Equations 16-22.

$$Constraint 1 : {\sum }_{1}^{d} {R}_{1 d} \leq M \qquad ( Equation 16 )$$

$$Constraint 2 : {\sum }_{1}^{d} {R}_{2 d} \leq M \qquad ( Equation 17 )$$

$$Constraint 3 : {\sum }_{1}^{d} {R}_{3 d} \leq M \qquad ( Equation 18 )$$

$$Constraint 4 : {\sum }_{1}^{d} {R}_{4 d} \leq M \qquad ( Equation 19 )$$

Equation 20 below can represent the constraint of integration costs, b1.

$$Constraint 5 : {\sum }_{i = 1}^{i = 4} {\sum }_{1}^{d} {C}_{1 , i d} \cdot {R}_{i d} \leq {b}_{1} \qquad ( Equation 20 )$$

Equation 21 below can represent the constraint of modernization costs, b2.

$$Constraint 6 : {\sum }_{i = 1}^{i = 4} {\sum }_{1}^{d} {C}_{2 , i d} \cdot {R}_{3 d} \leq {b}_{2} \qquad ( Equation 21 )$$

Equation 22 below can represent the constraint of resource consulting costs, b3.

$$Constraint 7 : {\sum }_{i = 1}^{i = 4} {\sum }_{1}^{d} {C}_{3 , i , a} \cdot {R}_{3 d} \leq {b}_{3} \qquad ( Equation 22 )$$

The program code can convert these scalar constraints in vectors by utilizing linear algebra to arrive at equations, such as the objection function below, labeled Equation 23 as well as Equation 24. In these equations, A is a matrix formed from scalar quantities.

$$Objective Function : Z = \vec{{C}_{1}} \cdot ( \vec{N} ) + \vec{V} \cdot {\vec{C}}_{2} + \vec{O} \cdot {\vec{C}}_{3} \qquad ( Equation 23 )$$

$$A \cdot \vec{X} < = \vec{b} \qquad ( Equation 24 )$$

$$Where : \vec{X} = [ \begin{matrix}\vec{N} \\ \vec{U} \\ \vec{O}\end{matrix} ] ; \vec{b} = [ M , M , M , M , M , {b}_{1} , {b}_{2} , {b}_{3} ] ;$$

The program code can arrive at a deterministic solution leveraging Equation 25 and by adding a slack variable. X_{B} represents basis vectors and a solution is provided at Equation 26.

$$[ [ A , I ] [ \begin{matrix}\vec{x} \\ {\vec{x}}_{s}\end{matrix} ] = \vec{b} \qquad ( Equation 25 )$$

$$B \cdot {x}_{B} = \vec{b} \qquad ( Equation 26 )$$

$${X}_{B} = {B}^{( - 1 )} \cdot \vec{b}$$

$${Z}_{m} i n = \vec{{C}_{B}} \cdot {B}^{( - 1 )} \cdot \vec{{X}_{B}}$$

In some examples, through deterministic integer programming, the program code can determine the candidates among the “Re-engineer” category, which can be re-factored (i.e., architected to align with strategic assessment and constraints of client).

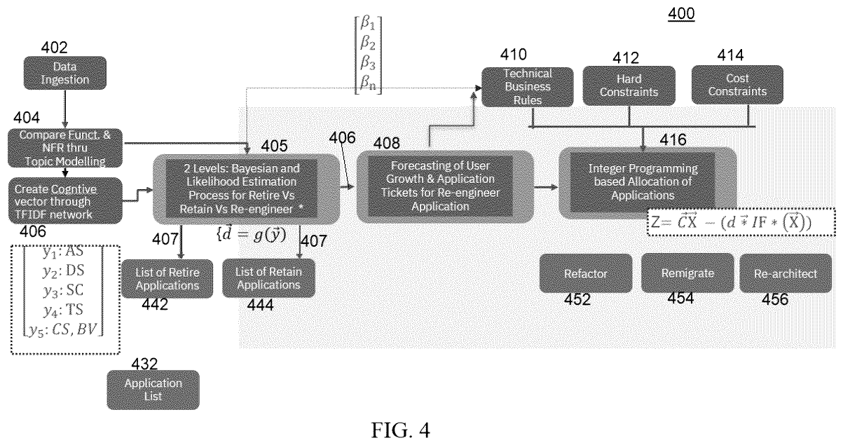

FIG. 4 provides a mathematical view 400 of aspects of the workflows 200 and 300 described in FIGS. 2-3. The program code dispositions and makes recommendations regarding migration of applications based on constraints, including, but not limited to, compliance parameters, business value, and cost. The program code ingests data (402) (e.g., based on subscribing to distributed system offerings). The program code utilizes an application scanner to compare functional and non-functional documents to compare depth of similarity between applications functional and on non-functional levels. The program code can compare the functional and non-functional requirements through topic modeling (404). The program code creates a vector to create an application score, a deployment score, and potentially other scores using TF-IDF architecture (machine learning). As illustrated in FIG. 4, the program code creates a cognitive vector utilizing TD-IDF (406). In some examples, the program code can predict a cognitive vector score of application migration with adaptability score, test score, deployment score, etc. Thus, the program code can utilize the weights of these scorings to predict cloud application migration disposition using Bayesian or likelihood estimates. Thus, the program code can classify the applications into different dispositions. The program code can utilize different types of classifiers to make this determination, including but not limited to Linear Discriminant Analysis (LDA) and/or Quadratic Discriminant Analysis (QDA). The program code can use LDA when a linear boundary is desired between classifiers and QDA to find a non-linear boundary between classifiers. The program code can predict the following dispositions for the applications: Refactor 452, Remigrate 454, Rearchitect 456, Retire 442, and Retain 444. As illustrated in FIG. 4, the program code can perform two levels of estimations, Bayesian and likelihood, to differentiate between applications to retire, retain, and re-engineer (e.g., refactor, remigrate, and/or re-architect) (406) for the application list 432. The program code filters out the applications that it has classified (using the various machine learning techniques described herein) as retired or retained (407) and to focus on optimizing the applications classified by as re-engineer group (405). The remainder of the program code can be understood as an optimization engine.

The program code optimizes the applications classified as “re-engineer”. The program code forecasts growth of application users to understand and verify the strategic intent of the application (408). To forecast the growth, the program code obtains business rules 410, hard constraints 412, and cost constraints 414 of the application.

FIG. 5 is an example of business rules that can be obtained by the program code in the examples herein and utilized to forecast application user growth. As illustrated in FIG. 5, parameters can include number of users, number of transactions, number of incidents, complexity, whether the application is planned/scheduled for decommission, redundant function, current business value, legacy application, legacy data, after migration business value, high total cost of ownership, cloud (or other target migration environment) amenability, strategic alignment, compliance (including geographic data storage rules), and/or ability to reap benefits of the cloud (or other new target environment) benefits after migration. As illustrated in FIG. 5, the variation in parameters translates to different cloud dispositions. The rearchitect disposition includes a high number of users, a high number of transactions, a high complexity, a high current business value and after migration business value, cloud amenability (readiness) is negative, strategic alignment is high, and after migration, one could reap benefit. Meanwhile, in the rehost category, the number of users in forecasted as greater than a 10% increase, the number of transactions is forecasted as greater than a 10% increase, the complexity is low, the current and post-migration business values are high, the application is amenable to cloud (migration), and the strategic alignment is high. For the replatform category, the number of users is high, the number of transactions is high, the complexity is low, the current business value is high, the application cannot be moved (legacy) and the data cannot be moved (legacy), the application is not amendable to a cloud (migration), but strategic alignment is high. For the refactor category, the number of users is high, the number of transactions is high, the complexity is high, the current business value is high, the application can be moved (legacy) and the data can be moved (legacy), the application is amendable to a cloud (migration), and strategic alignment is high. For applications categorized by the program code to be repurchased, the number of users is high, as is the number of transactions. The complexity for repurchase is low, but the current and after migration business values are high, as is the total cost of ownership.

Embodiments of the present invention include computer-implemented methods, computer systems, and computer program products for determining resource dispositions for applications in a distributed computing environment. In some examples, program code executed by one or more processors ingests data from one or more computing environments, wherein the data is related to the applications. The program code identifies, based on utilizing topic modeling and latent semantic analysis of the data, homogenous applications among the applications. To identify the homogenous applications the program code analyzes subdata handled by each application and functionalities of each application. The homogenous applications comprise similarities in the subdata and in the functionalities. The program code determines overlapping data among the homogenous applications based on the topic modeling, the latent semantic analysis, and term frequency-inverse document frequency of terms in the overlapping data. The program code selects, from the overlapping data of the homogenous applications, training data. The program code utilizes the training data to calculate weights for disposition metrics. The program code predicts, based on the disposition metrics, the resource dispositions for the applications.

In some examples, the resource dispositions are selected from the group consisting of: retire, retain, and re-engineer.

In some examples, the program code determines additional dispositions for a subset of applications predicted for the re-engineer disposition integer programming.

In some examples, the resource dispositions comprise cloud dispositions.

In some examples, the data for each application comprises a functional requirements document and non-functional requirements.

In some examples, the ingesting comprises: the program code generating a table where the table, for each application of the applications, stores parameters including one or more of: application identifier, client, domain, functional document name, non-functional requirement document name, and data attribute.

In some examples, the topic modeling comprises: the program code applying an unsupervised machine learning algorithm to convert unstructured content in the data into structured formats based on detecting word and phrase patterns within the unstructured content; and the program code clustering word groups and similar expressions in the structured formats, where in the word groups and the similar expressions characterize documents of the homogenous applications.

In some examples, the latent semantic analysis comprises: the program code identifying different topics in the data to determine the functionalities of the applications. The analysis also includes the program code determining an extent of overlap between the functionalities of the applications based on overlaps between the different topics in the data. The analysis also includes the program code identifying the homogenous applications as being most similar applications based on the extent of the overlap.

In some examples, the program code identifying the different topics comprises the program code utilizing a natural language processing to identify the different topics.

In some examples, utilizing the natural language processing comprises applying a bag-of-words model.

In some examples, the program code analyzing the subdata handled by each application and the functionalities of each application further comprises: the program code utilizing machine learning to determined term frequency-inverse document frequency of strings in the subdata to quantify importance of the strings of the subdata, wherein the strings of the subdata comprise the terms.

In some examples, the program code utilizing the training data to calculate the weights for the disposition metrics comprises: the program code calculating an intermediate function to determine a target variable for each disposition of the dispositions.

In some examples, the target variable comprises a cognitive vector.

In some examples, the disposition metrics can include one or more of: code scalability, change adaptability, testable adaptability, deployment adaptability, and/or general architecture scalability.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of determining resource dispositions for applications in a distributed computing environment, the method comprising:
ingesting, by one or more processors, data from one or more computing environments, wherein the data is related to the applications;
identifying, by the one or more processors, based on utilizing topic modeling and latent semantic analysis of the data, homogenous applications among the applications, wherein the identifying comprises:
analyzing, by the one or more processors, subdata handled by each application and functionalities of each application, and wherein the homogenous applications comprise similarities in the subdata and in the functionalities;
determining, by the one or more processors, overlapping data among the homogenous applications based on the topic modeling, the latent semantic analysis, and term frequency-inverse document frequency of terms in the overlapping data;
selecting, by the one or more processors, from the overlapping data of the homogenous applications, training data;
utilizing, by the one or more processors, the training data, to calculate weights for disposition metrics; and
predicting, by the one or more processors, based on the disposition metrics, the resource dispositions for the applications.

2. The method of claim 1, wherein the resource dispositions are selected from the group consisting of: retire, retain, and re-engineer.

3. The method of claim 2, further comprising:
determining, by the one or more processors, additional dispositions for a subset of applications predicted for the re-engineer disposition integer programming.

4. The method of claim 1, wherein the resource dispositions comprise cloud dispositions.

5. The method of claim 1, wherein the data for each application comprises a functional requirements document and non-functional requirements.

6. The method of claim 1, wherein the ingesting comprises:
generating, by the one or more processors, a table, wherein the table, for each application of the applications, stores parameters, wherein the parameters are one or more of application identifier, client, domain, functional document name, non-functional requirement document name, and data attribute.

7. The method of claim 1, wherein the topic modeling comprises:
applying, by the one or more processors, an unsupervised machine learning algorithm to convert unstructured content in the data into structured formats based on detecting word and phrase patterns within the unstructured content; and
clustering, by the one or more processors, word groups and similar expressions in the structured formats, where in the word groups and the similar expressions characterize documents of the homogenous applications.

8. The method of claim 1, wherein the latent semantic analysis comprises:
identifying, by the one or more processors, different topics in the data to determine the functionalities of the applications;
determining, by the one or more processors, an extent of overlap between the functionalities of the applications based on overlaps between the different topics in the data; and
identifying, by the one or more processors, the homogenous applications as being most similar applications based on the extent of the overlap.

9. The method of claim 8, wherein identifying the different topics comprises utilizing a natural language processing to identify the different topics.

10. The method of claim 9, wherein utilizing the natural language processing comprises applying a bag-of-words model.

11. The method of claim 1, wherein analyzing the subdata handled by each application and the functionalities of each application further comprises:
utilizing, by the one or more processors, machine learning to determined term frequency-inverse document frequency of strings in the subdata to quantify importance of the strings of the subdata, wherein the strings of the subdata comprise the terms.

12. The method of claim 2, wherein utilizing the training data to calculate the weights for the disposition metrics comprises:
calculating, by the one or more processors, an intermediate function to determine a target variable for each disposition of the dispositions.

13. The method of claim 12, wherein the target variable comprises a cognitive vector.

14. The method of claim 1, wherein the disposition metrics comprise one or more of: code scalability, change adaptability, testable adaptability, deployment adaptability, and general architecture scalability.

15. A computer system for determining resource dispositions for applications in a distributed computing environment, the computer system comprising:
a memory; and
one or more processors in communication with the memory, wherein the computer system is configured to perform a method, said method comprising:
ingesting, by the one or more processors, data from one or more computing environments, wherein the data is related to the applications;
identifying, by the one or more processors, based on utilizing topic modeling and latent semantic analysis of the data, homogenous applications among the applications, wherein the identifying comprises:
analyzing, by the one or more processors, subdata handled by each application and functionalities of each application, and wherein the homogenous applications comprise similarities in the subdata and in the functionalities;
determining, by the one or more processors, overlapping data among the homogenous applications based on the topic modeling, the latent semantic analysis, and term frequency-inverse document frequency of terms in the overlapping data;
selecting, by the one or more processors, from the overlapping data of the homogenous applications, training data;
utilizing, by the one or more processors, the training data, to calculate weights for disposition metrics; and
predicting, by the one or more processors, based on the disposition metrics, the resource dispositions for the applications.

16. The computer system of claim 15, wherein the resource dispositions are selected from the group consisting of: retire, retain, and re-engineer.

17. The computer system of claim 16, further comprising:
determining, by the one or more processors, additional dispositions for a subset of applications predicted for the re-engineer disposition integer programming.

18. The computer system of claim 15, wherein the resource dispositions comprise cloud dispositions.

19. The computer system of claim 15, wherein the data for each application comprises a functional requirements document and non-functional requirements.

20. A computer program product for determining resource dispositions for applications in a distributed computing environment, the computer program product comprising:
one or more computer readable storage media and program instructions collectively stored on the one or more computer readable storage media readable by at least one processing circuit to perform a method comprising:
ingesting, by the one or more processors, data from one or more computing environments, wherein the data is related to the applications;
identifying, by the one or more processors, based on utilizing topic modeling and latent semantic analysis of the data, homogenous applications among the applications, wherein the identifying comprises:
analyzing, by the one or more processors, subdata handled by each application and functionalities of each application, and wherein the homogenous applications comprise similarities in the subdata and in the functionalities;
determining, by the one or more processors, overlapping data among the homogenous applications based on the topic modeling, the latent semantic analysis, and term frequency-inverse document frequency of terms in the overlapping data;
selecting, by the one or more processors, from the overlapping data of the homogenous applications, training data;
utilizing, by the one or more processors, the training data, to calculate weights for disposition metrics; and
predicting, by the one or more processors, based on the disposition metrics, the resource dispositions for the applications.
